(19) United States
(12) Patent Application Publication
(10) Pub. No.: US 2009/0157997 A1
(43) Pub. Date: Jun. 18, 2009

(54) USING IN-LEAF MULTIPLE TRIANGLE PACKING FOR KD-TREES SIZE REDUCTION

(76) Inventor: ALEXEI LEONENKO, Moscow (RU)

Correspondence Address: CARRIE A. BOONE, P.C., 2450 Louisiana, Suite # 400-711, HOUSTON, TX, 77006, US

(21) Appl. No.: 11/957,365

(22) Filed: Dec. 14, 2007

(51) Int. Cl. G06F 12/02; G06F 17/30

(52) U.S. Cl. 711/171; 707/100; 707/102; 711/E12.002; 707/E17.044

(57) ABSTRACT

Embodiments of a binary layout and packing scheme are disclosed for storing kd-tree information. Information about triangles belonging to the tree leaf may be stored inside the leaf structure itself. Multiple triangles in a corresponding leaf may be stored in the leaf of the kd-tree structure.

### TECHNICAL FIELD

This application relates to efficient storage of kd-trees.

### BACKGROUND

Implementing scene visualization with the help of ray tracing involves special purpose acceleration structures known as k-dimensional trees (“kd-trees”). Every intermediate node corresponds to a sub-region of a scene and contains information about split plane position/plane orientation with a pointer to lower levels of the tree (sub-division hierarchy). Terminal leafs contain a pointer/offset to a list of objects or indexes of the objects that lie inside the corresponding sub-region.

In FIG. 1, a bounding region 50 has four triangles: A, B, C, and D. A split along line X=X₀ is followed by splits along lines X=X₁, Y=Y₀, then Y=Y₁, Y=Y₂ and Y=Y₃. Six orthogonal lines, X₀, X₁, Y₀, Y₁, Y₂, and Y₃, subdivide the bounding region 50 into seven sub-regions. A kd-tree structure 60 (FIG. 2) represents the subdivision of the bounding region 50 (FIG. 1). The structure 60 has six internal nodes (white), three empty leafs (checkered), and four leafs with attached triangles (speckled). FIG. 3 shows an 8-byte memory portion 72A for storing internal (intermediate) node information and an 8-byte memory portion 72B for storing leaf (terminal) node information. The memory portions 72A, 72B are used in the binary layout 70 (FIG. 4). To store this data structure compactly, every node is stored in eight bytes. For the internal (intermediate) nodes, the 64 bits 72A are distributed as follows: one bit 74 encodes a node type and distinguishes a terminal node from intermediate nodes; 29 bits 76 store a memory offset to the left sub-node; two bits 78 store the subdivision direction; and 32 bits 62 store subdivision position (floating point format). For terminal nodes, one bit 64 encodes a node type and indicates either terminal or intermediate node; 31 bits 66 encode the relative memory offset to the list of corresponding triangle indexes; and 32 bits 68 encode the triangle number of triangles in the corresponding sub-region. Triangle index lists are stored at the end using 32 bits per triangle index.

A binary layout 70 for the kd-tree 60 is depicted in FIG. 4. For data aligning purposes, sub-nodes are allocated in pairs, the right sub-node immediately following the left one. The root node at the top (X₀) is followed by a dummy node, which contains arbitrary information. To store thirteen nodes, as described above, plus one dummy node, 112 bytes are used (8 bytes per node), followed by twenty bytes to store triangle indexes lists (four bytes per triangle), resulting in a total of 132 bytes. Each triangle index list block 90 of the binary layout 70 corresponds to the four bytes of memory representing triangle index, and is marked by the triangle letter.

Each node byte block 88 of the binary layout 70 corresponds to the eight bytes of memory representing the kd-tree node. Intermediate nodes are marked by split location and offset pair. Terminal nodes are marked by triangle number and offset pair. The first block 88 of the binary layout 70 indicates “X₀, 16”, where “X₀” indicates the first split position X₀ of the top node of the kd-tree 60 and “16” is an offset in bytes from the beginning of the node to the connected node, X₁. The other node extending from X₀, Y₀, is in the next block after the X₁ block. Arrows indicate this progression along the intermediate nodes. The terminal nodes are also stored in the binary layout 70. The triangle A is contained within the subdivision of the bounding region 50 designated Y₃ (FIG. 2). The fifth block 88 of the binary layout 70 indicates “Y₃, 16”, the intermediate node “Y₃” and an offset “16” to the block 88 designated “1, 64”. In this block, the “1” indicates that there is one triangle stored, while the “64” is an offset in the binary layout 70 to the block 90, indicating “A”. The triangle index list block 90 actually stores the index of A. The triangle indexes for triangles A, B, C, and D, with D being stored twice because it has two portions in two different bounding regions (see FIG. 1), are stored at the very end of the binary layout 70.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a graph of a sample hierarchical subdivision, according to the prior art;

FIG. 2 is a sample kd-tree structure for the graph of FIG. 1, according to the prior art;

FIG. 3 is a block diagram showing memory allocation for the binary layout of FIG. 4, according to the prior art;

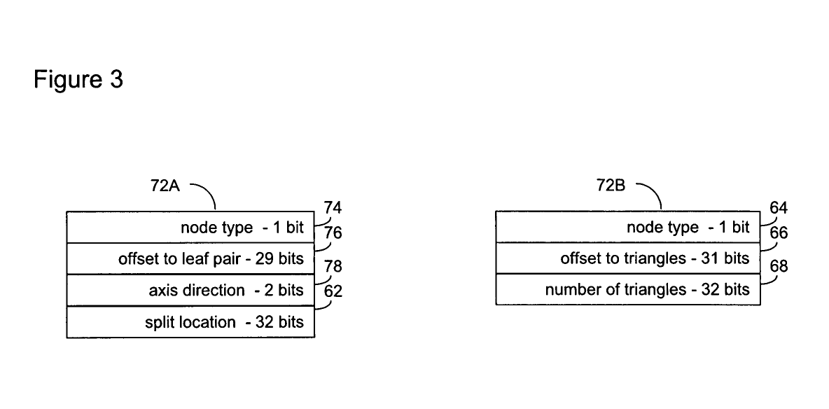

FIG. 4 is a binary layout of the kd-tree structure of FIG. 2, according to the prior art;

FIG. 5 is a binary layout of the kd-tree structure of FIG. 2 with in-leaf packing, according to some embodiments;

FIG. 6 is a block diagram showing memory allocation for the binary layout of FIG. 5, according to some embodiments; and

FIG. 7 is a flow diagram for generating the binary layout of FIG. 5, according to some embodiments.

### DETAILED DESCRIPTION

In accordance with the embodiments described herein, a binary layout and method for storing kd-tree information about triangles belonging to the tree leaf inside the leaf structure itself are disclosed. Multiple triangles in a corresponding leaf may be stored in the leaf of the kd-tree structure. Embodiments of the invention also provide compression of the kd-tree, as well as a slight increase in performance.

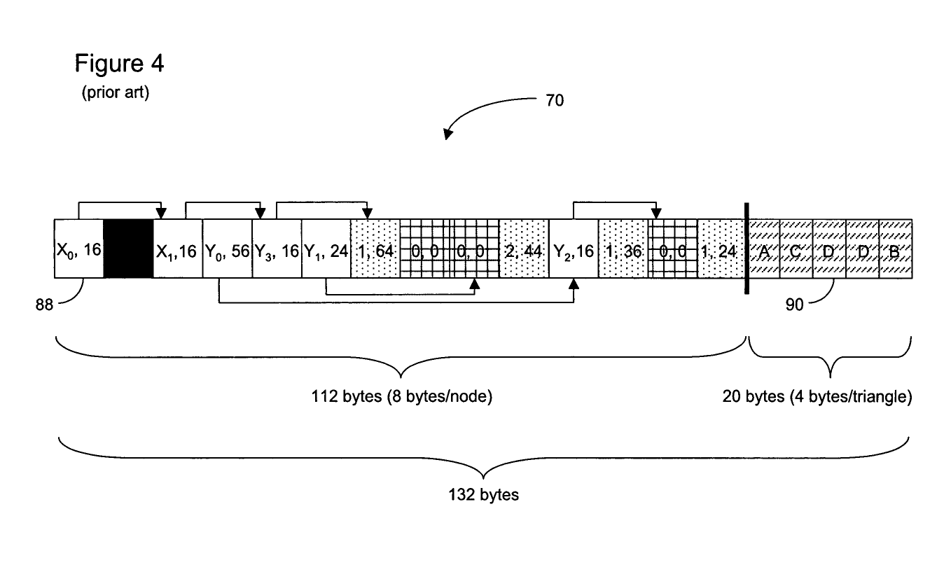

In the example of FIG. 4, the depth of the tree required to achieve high rendering performance is usually sufficient enough for nearly 90% of leafs to contain less than five triangles. For bounding regions with such characteristics, a novel binary layout 100 is proposed. This binary layout 100 uses less memory than is used in the binary layout 70 of FIG. 4. Further, in some embodiments, a slight performance increase is obtained.

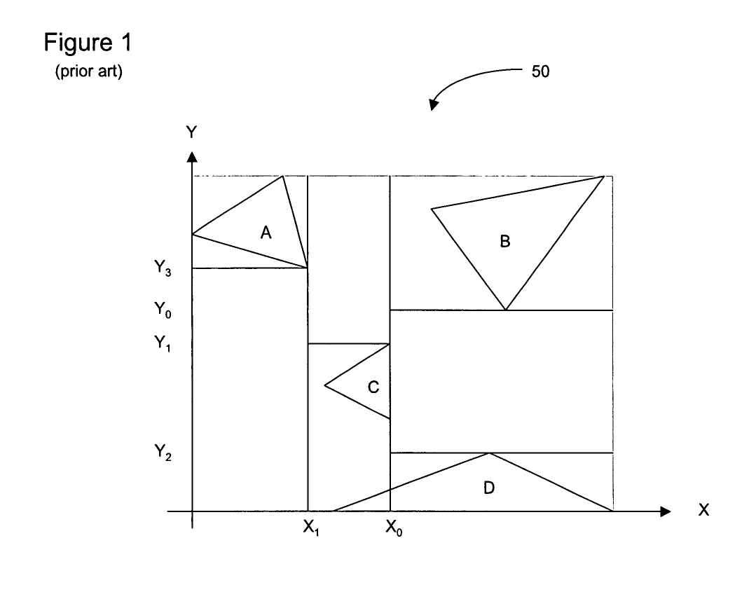

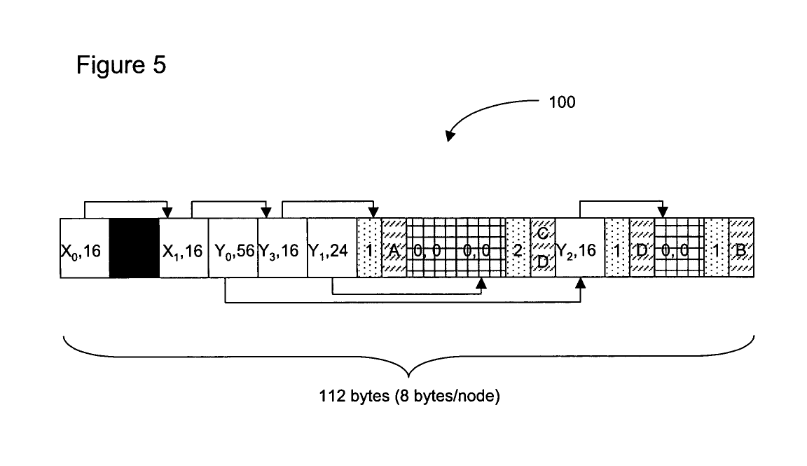

An embodiment of the binary layout 100 is depicted in FIG. 5. The binary layout 100 may exploit the condition in which multiple triangles occupy the same bounding region. Recall in FIG. 1 that the triangle C and part of the triangle D occupy the subdivision Y₁ of the bounding region 50. In the embodiment of the binary layout 100, information about the multiple triangles is placed inside the corresponding leaf, rather than occupying a separate memory location at the end.

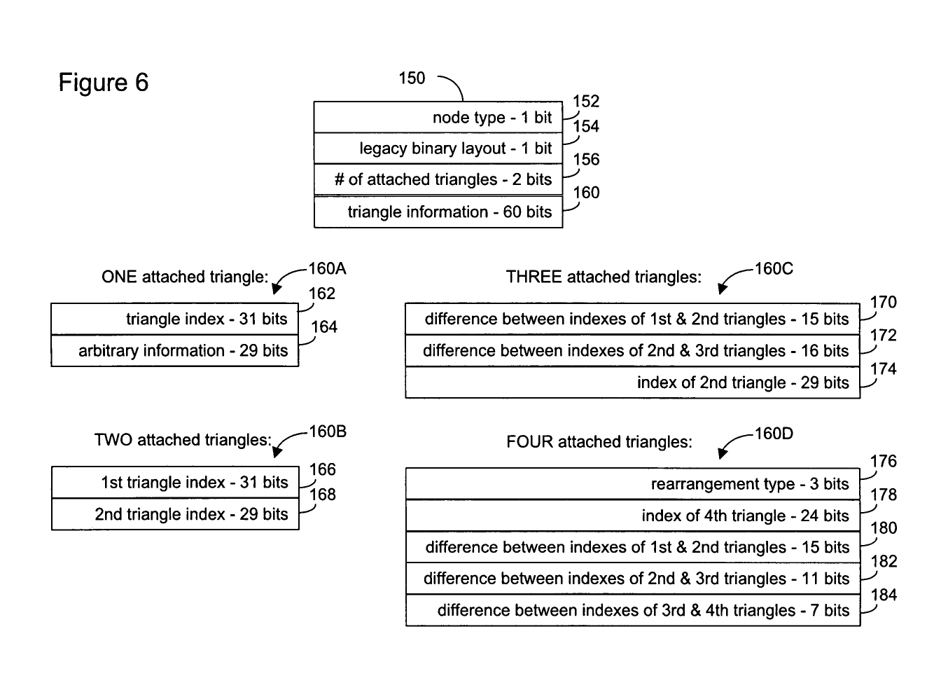

As with the binary layout 70, in the embodiment of the binary layout 100, every node of the tree may be stored using eight bytes (64 bits) of memory. The memory allocation may be different, however, depending on the number of triangles in the bounding region 50, with some common bits. FIG. 6 is a diagram of one embodiment of the memory allocation 150 for the novel binary layout 100 of FIG. 5. The information regarding the bounding region 50 may be stored in a 64-bit memory. For terminal nodes with one, two, three, or four attached triangles, the 64 bits may be distributed as follows: one bit 152 may be used to encode a node type and distinguish a terminal nodes from intermediate ones; one bit 154 may be used to distinguish between binary layout 70 (legacy) and the binary layout 100 used to encode this node; two bits 156 may be used to store the number of attached triangles (zero-based), whether one, two, three, or four. The remaining 60 bits 160 may be allocated differently, depending on the number of triangles. Triangle information 160A may be used when there is one triangle; triangle information 160B may be used when there are two triangles; triangle information 160C may be used when there are three triangles; and triangle information 160D may be used when there are four triangles (collectively, triangle information 160).

Where there is one attached triangle, triangle information 160A may be used as follows: 31 bits 162 may be used to store the triangle index, and the remaining 29 bits 164 may be used to store arbitrary information. Where there are two attached triangles, triangle information 160B may be used: 31 bits 166 may be used to store the index of the first triangle and 29 bits 168 may be used to store the index of the second triangle. Where there are three attached triangles, triangle information 160C may be used. The triangles are first rearranged in decreasing order. Then, fifteen bits 170 may be used to store the difference between the indexes of the first and the second triangles, sixteen bits 172 may be used to store the difference between the indexes of the second and the third triangles, and 29 bits 176 may be used to store the index of the second triangle.

Where there are four attached triangles, triangle information 160D may be used. First, the triangles may be rearranged in decreasing order. Further, the first index may be reduced by three, the second index may be reduced by two, and the third index may be reduced by one. Then, the difference between the first and second indexes may be found, the difference between the second and third indexes may be found, and the difference between the third and fourth indexes may be found. These differences may be rearranged and the rearrangement type may be stored in three bits 176, the fourth triangle index may be stored using 24 bits 178, the first (biggest) difference may be stored using fifteen bits 180, the second (middle) difference may be stored using eleven bits 182, and the third (smallest) difference may be stored using seven bits 184. For terminal nodes with a number greater than four attached triangles, for intermediate nodes and for the cases, the binary layout 70 may be used, in some embodiments, as it may not be possible to use data layout 100.

The bit allocations shown in FIG. 6 may be modifiable, in some embodiments. For example, in the four triangles case, where the differences are stored in 15, 11, and 7 bits, the rearrangement part may be removed, and the differences instead be stored in 16, 12, and 8 bits. Those with ordinary skill in the art will recognize a number of different approaches that may be taken to successfully store the triangle information.

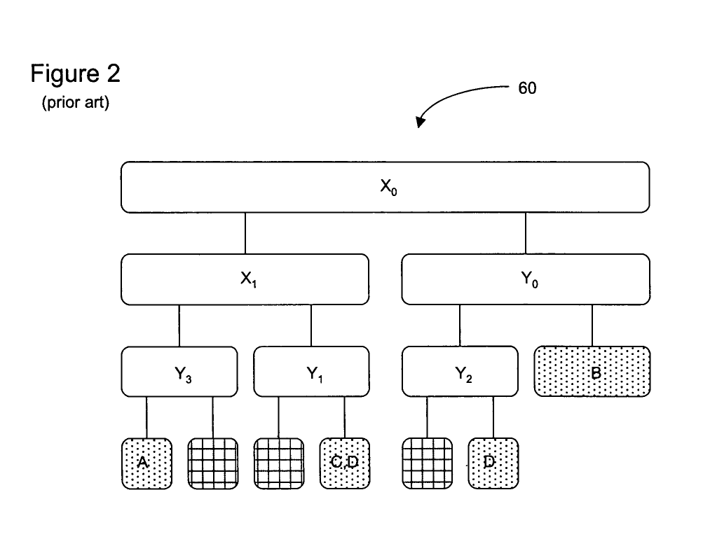

As with the binary layout 70, embodiments of the binary layout 100 may be derived from the bounding region 50 (FIG. 1) and the kd-tree 60 (FIG. 2). Thus, in looking at the binary layout 100, it may be helpful to review the kd-tree 60. All blocks used for intermediate nodes may remain unchanged, as the blocks depicting non-empty terminal nodes are modified. Instead of “1,64” (FIG. 4), the terminal node may be labeled “1,A”, since, with binary layout 100, the index of the triangle A is stored, not at the end of the binary layout, but directly inside the node. Instead of “2,44” (FIG. 4), node 10 may be labeled “2,C/D”, storing the indexes of the C and D triangles inside the node, as described above. The overall size for the kd-tree structure may now be 112 bytes. Compared with the 132 bytes of the binary layout 70, embodiments of the binary layout 100 may provide a 15% memory conservation.

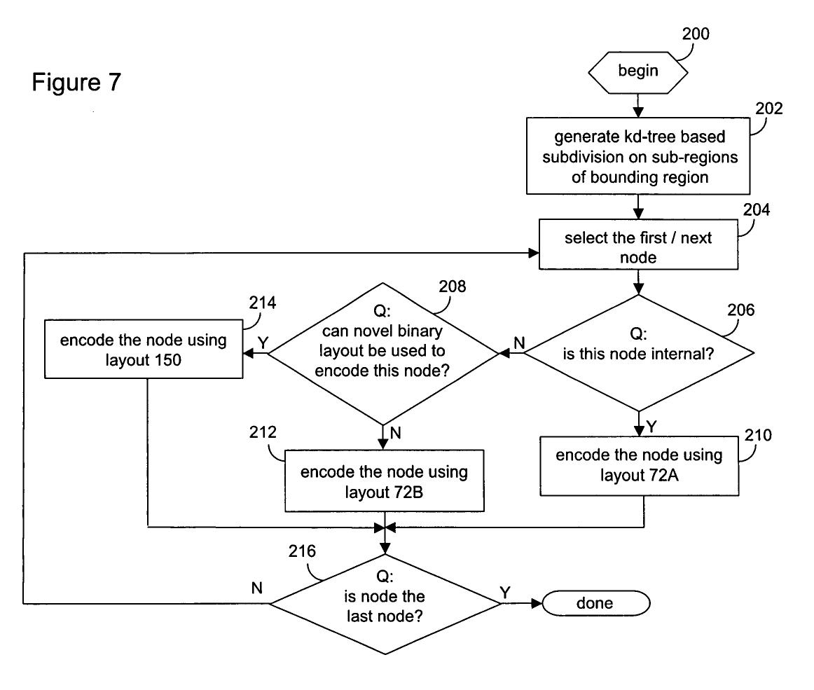

FIG. 7 is a flow diagram illustrating one embodiment of a packing scheme 200 for generating the binary layout 100 of FIG. 5. The packing scheme 200 commences by building a kd-tree by sub-dividing a bounding region into a number of distinct sub-regions, as described above (block 202). The binary layout to be generated may replace an internal kd-tree representation node with the compact binary layout 100 representation.

For every kd-tree node, an embodiment of the packing scheme 200 may proceed by determining whether the current node is an internal node in the corresponding sub-region (block 206). If so, a legacy binary layout (e.g., binary layout 70 of FIG. 4) may be used, with the memory allocation 72A (block 210). Otherwise, for a given terminal node, a determination may be made whether the node has four or fewer triangles and whether the binary layout 100 may be used for this node (block 208). If so, the binary layout 100 may be used to store the node and the attached triangle indexes (block 214). If not, a legacy binary layout with the memory allocation 72B may be used (block 212) to store the node. The process repeats until all nodes have been analyzed (block 216).

In some embodiments, the binary layout 100 may not be possible for all nodes with four or fewer triangles. For example, where the node has four triangles, the novel binary layout 100 may be used if the rearrangements and differences between the triangle indexes can be encoded with 15 bits, 11 bits, and 7 bits, as described above.

Embodiments of the binary layout 100 provide both memory conservation (5% to 20%) and increased memory access coherence for typical search paths. Embodiments of the binary layout 100 operate by difference encoding and is described in detail in the pseudo-code listed at the end of this document. Up to four triangles may be packed, thus covering a majority of leafs for the deep trees. If the packing attempt fails, the old scheme (e.g., binary layout 70) may be used to store the information about the leaf triangles. Embodiments of the binary layout 100 may be used in any hardware or software implementations of kd-tree structures for ray-tracing.

Embodiments of the binary layout 100 thus enable information about multiple triangles to be placed inside the kd-tree node structure (be it a terminal node or an intermediate node). Embodiments of the method 200 for generating the binary layout 100 (FIG. 7, and described further in FIG. 6), may use two distinct differential encoding schemes to store triangle indexes in compact form. In the three triangles case, the differences may be encoded. In the four triangles case, differences may be rearranged to fit within the limitations of the bit allocation.

Pseudo code (C type) sample: Triangle encoding procedure (leafs with 1, 2, 3 and 4 triangles):

```
typedef struct lNode{
  int flag_k_ofs;
  union _tree_data{
```

| | |
|---|---|
| float | split; |
| int | items; |

```
    }tree_data;
  } slNode;
```

| | |
|---|---|
| int | size = ...; /* INPUT: number of the |

triangles in leaf */

| | |
|---|---|
| int | *trng = ...; /* INPUT: triangles IDs */ |
| slNode | pLeaf; /* OUTPUT: 8 bytes of |

packed leaf information */

| | |
|---|---|
| int | a, b, c, d, t, ta, tb, tc, td, |

```
  pack_type;
  switch(size) {
    case 1:
      if(trng[0]>=0) {
```

pLeaf->flag_k_ofs =

trng[0]|0x80000000;

pLeaf->tree_data.items = 0x80000000;

```
      }
      break;
    case 2:
      a = trng[0]; b = trng[1];
      if((a>=0)&&(b>=0)){
```

if(a>0x01FFFFFFF) { b = a; a = trng[1];

}

if(a<=0x01FFFFFFF) {

```
          pLeaf->flag_k_ofs  =
  b|0x80000000;
          pLeaf->tree_data.items =
  (a<<2)|0x80000001;
        }
      }
      break;
    case 3:
      a = trng[0]; b = trng[1]; c = trng[2];
      if((a>=0)&&(b>=0)&&(c>=0)){
```

if(b < a) { a = b; b = trng[0]; };
if(c < a) { c = b; b = a; a = trng[2]; }
else if(c < b) { c = b; b = trng[2]; }
a = b−a; c = c−b;

```
        if((b<=0x01FFFFFFF)&&(a<=0x7FFF)&&(c<=0xFFFF)) {
                pLeaf->flag_k_ofs  =
        0x80000000|(a<<16)|c;
                pLeaf->tree_data.items =
        (b<<2)|0x80000002;
              }
            }
            break;
          case 4: {
            a = trng[0]; b = trng[1]; c = trng[2]; d =
        trng[3];
            if(b > a) { a = trng[1]; b = trng[0]; }
            if(d > c) { c = trng[3]; d = trng[2]; }
            if(c > a) { t = a; a = c; c = t; }
            if(d > b) { t = d; d = b; b = t; }
            if(c > b) { t = c; c = b; b = t; }
            a −= 3; b −= 2; c −= 1; ta = a − b; tb = b −
        c; tc = c − d; pack_type = 0;
            if((d>=0)&&(ta>=0)&&(tb>=0)&&(tc>=0)) {
              if(tc > tb) { pack_type = 1; td = tc;
        tc = tb; tb = td; };
              if(tb > ta) {
                pack_type |= 2; td = tb; tb = ta; ta =
        td;
                if(tc > tb) { pack_type |= 4; td =
        tc; tc = tb; tb = td; };
              };
        if((d<(1<<25))&&(ta<(1<<16))&&(tb<(1<<12))&&(tc<(1<<
        8))){
                pLeaf->flag_k_ofs  =
        0x80000000|(d<<7)|tc;
                pLeaf->tree_data.items =
        0x80000003|(pack_type<<2)|(tb<<5)|(ta<<16);
              }
            }
            }
            break;
          default:
            break;
        }
```

While the application has been described with respect to a limited number of embodiments, those skilled in the art will appreciate numerous modifications and variations therefrom. It is intended that the appended claims cover all such modifications and variations as fall within the true spirit and scope of the invention.

1. A binary layout representative of a kd-tree of a bounding region, the bounding region comprising a number of sub-regions, the binary layout comprising:
a plurality of node bytes to store nodes of the kd-tree, one node byte for each kd-tree node, the plurality of node bytes further comprising:
a first node, wherein the first node is stored in the binary layout using a first memory allocation;
a second node comprising no triangles or five or more triangles, wherein the second node is stored in the binary layout using a second memory allocation; and
a third node comprising four or fewer triangles, wherein the third node is stored in the binary layout using a third memory allocation, the third memory allocation storing a triangle information for each triangle in the third node.

2. The binary layout of claim 1, wherein the third memory allocation comprises:
a node type for the third node;
an indication whether the binary layout is legacy or not; and
an indication of how many triangles are in the third node.

3. The binary layout of claim 2, wherein the third node comprises one triangle and the third memory allocation further comprises:
an index for the one triangle.

4. The binary layout of claim 3, wherein 31 bits are used to store the index for the one triangle.

5. The binary layout of claim 2, wherein the third node comprises two triangles and the third memory allocation comprises:
a first triangle index for a first triangle of the two triangles; and
a second triangle index for a second triangle of the two triangles.

6. The binary layout of claim 2, wherein 31 bits are used to store the first triangle index and 29 bits are used to store the second triangle index.

7. The binary layout of claim 2, wherein the third node comprises three triangles and the third memory allocation comprises:
a first difference between indexes of a first triangle and a second triangle of the three triangles;
a second difference between indexes of the second triangle and a third triangle of the three triangles; and
an index of the second triangle.

8. The binary layout of claim 7, wherein fifteen bits are used to store the first difference, sixteen bits are used to store the second difference, and 29 bits are used to store the index.

9. The binary layout of claim 2, wherein the third node comprises four triangles and the fourth memory allocation comprises:
a rearrangement type;
an index of the fourth triangle;
a first difference between indexes of a first triangle and a second triangle of the four triangles;
a second difference between indexes of the second triangle and a third triangle of the four triangles; and
a third difference between indexes of the third triangle and a fourth triangle of the four triangles.

10. The binary layout of claim 9, wherein three bits are used to store the rearrangement type, 24 bits are used to store the index, fifteen bits are used to store the first difference, eleven bits are used to store the second difference, and seven bits are used to store the third difference.

11. The binary layout of claim 1, wherein the node bytes are not followed by a triangle index list.

12. A method to generate a binary layout, the method comprising:
selecting a node of a kd-tree, the kd-tree being representative of a bounding region, the bounding region comprising subdivisions, wherein one or more subdivisions comprises at least one triangle;
encoding the node within the binary layout without using a triangle index list if the node comprises with four or fewer triangles; and
encoding the node within the binary layout with a triangle index if the node comprises more than four triangles.

13. The method of claim 12, further comprising:
encoding the node with a first memory allocation if the node comprises zero triangles or more than four triangles.

14. The method of claim 12, further comprising:
encoding the node with a intermediate node memory allocation if the node is a second node.

15. The method of claim 12, encoding the node within the binary layout without using a triangle index list if the node comprises four or fewer triangles further comprising:
allocating 31 bits for storing a triangle index in the binary layout if there is one triangle in the node.

16. The method of claim 12, encoding the node within the binary layout without using a triangle index list if the node comprises four or fewer triangles further comprising:
allocating 31 bits for storing a first triangle index in the binary layout and allocating 29 bits for a second triangle index if there are two triangles in the node.

17. The method of claim 12, encoding the node within the binary layout without using a triangle index list if the node comprises four or fewer triangles further comprising:
allocating fifteen bits for storing a difference between indexes of a first triangle and a second triangle, allocating sixteen bits for storing a difference between indexes of the second triangle and a third triangle, and allocating an index of the second triangle if there are three triangles in the node.

18. The method of claim 12, encoding the node within the binary layout without using a triangle index list if the node comprises four or fewer triangles further comprising:
allocating three bits for a rearrangement type, allocating 24 bits for an index of a fourth triangle, allocating fifteen bits for a difference between indexes of a first triangle and a second triangle, allocating eleven bits for a second difference between indexes of the second triangle and a third triangle, and allocating a third difference between indexes of the third triangle and a fourth triangle if there are four triangles in the node.
